(19) United States
(12) Patent Application Publication
(10) Pub. No.: US 2024/0180184 A1
(43) Pub. Date: Jun. 6, 2024

(54) Sterilization of larvae infested cheese by exposure to extreme temperatures

(71) Applicant: Alex M. Garvin, Brunstatt (FR)

(72) Inventor: Alex M. Garvin, Brunstatt (FR)

(73) Assignee: Alex M. Garvin, Brunstatt (FR)

(21) Appl. No.: 18/061,429

(22) Filed: Dec. 3, 2022

(51) Int. Cl. A23C 19/097

(52) U.S. Cl. CPC A23C 19/0973

(57) ABSTRACT

The present invention provides methods for the treatment of larvae infested cheese in order to kill said larvae thus rendering the cheese safe for human consumption. This inventive method has utility in the food science field.

### BACKGROUND OF THE INVENTION

Casu marzu is a type of cheese made in Sardinia, Italy from sheep's milk where the cheese is exposed to Piophila casei flies that lay their eggs on the cheese (ref Manca). The eggs hatch into larvae that grow in the cheese and metabolize it to produce complex flavors, resulting in a food product considered a delicacy by the local population with annual production estimated to be 100 tons. Production would be much higher if it were not for the fact that in 1962 the Italian government banned casu marzu due to health concerns. Casu marzu poses a health risk due to the consumption of live larvae, which can grow in the stomach and intestine of the consumer and cause myiasis, a parasitic infestation of fly larvae (ref Peckenschneider).

Parasites are living organisms that derive nourishment and protection from other living organisms, and when found in food they can cause diseases in humans. Temperature treatment of casu marzu that kills the larvae will result in a food product that does not contain parasites because once the larvae are dead they cannot live in a human host, and by definition cannot be considered parasites.

In order to make casu marzu safe and legal, the larvae must be killed in such a way that the mortality rate is essentially 100%. The treatment used to kill the larvae may result in changes to the texture, nutritional value, and taste of the cheese, but these changes can be kept to a minimum so that consumers remain interested in the product while at the same time permitting its approval by health authorities. Lastly, the killing process should be fast, safe, inexpensive, easily performed, and acceptable to both the health authorities and consumers.

Piophila casei larvae are roughly 5 mm in length and 1 mm in diameter and contain millions of cells. These organisms have a nervous system, a digestive system, musculature, and all other physiological systems needed for survival and growth. Furthermore, these larvae are adapted to live in mild temperatures, with 25° C. being the ideal growth temperature. Therefore, 0° C. or below is lethal for these larvae because they are not adapted to resist ice crystallization. Similarly, high temperatures are also fatal. Although no data are available for temperature lethality in Piophila casei larvae, the effects of high temperatures on survival of two forensically important flies that live at temperatures similar to Piophila casei, Phormia regina and Lucilia sericata, have been performed. Both P. regina and L. sericata show 0% survival at 44° C.(ref Monzon). It should be noted that the most heat resistant insect described to date is the ant Cataglyphis bicolor that lives in the Sahara desert and has a critical thermal maximum (defined as the temperature at which at least 50% of the ants die or lose muscular coordination after 10 min of exposure) of 55.1+/−1.1 degrees C. (ref Gehring).

The European Food Safety Authority has authorized three insect species for human consumption; yellow mealworms, crickets, and grasshoppers. The insects are sold in frozen, dried, or powdered form, treatments that insure an insect mortality rate of 100%. The yellow mealworms currently approved for human consumption are the larval form of the yellow mealworm beetle Tenebrio molitor. Preparation of the mealworms requires treatment with boiling in water for at least 2 minutes to expose the sample to temperatures >90° C.(ref Turck D) which ensures complete killing of all larvae.

Biogenic amines such as tyramine, putrescine and cadaverine are produced during the ripening of casu marzu and contribute to its unique taste. These molecules are heat-stable at 100° C. For example, the boiling point of tyramine is 175° C., putrescine is 159° C. and cadaverine is 179° C. The temperature at which these biogenic amines thermally decompose is by definition higher than the boiling point, therefore these molecules are stable well above 100° C. Biogenic amines are also stable below 0° C. The difference between the thermo-stability of biogenic amines and the thermo-sensitivity of Piophila casei larvae form the basis of making casu marzu safe by extreme temperature treatment without damaging its unique taste. At least one specification heading is required. Please delete this heading section if it is not applicable to your application. For more information regarding the headings of the specification, please see MPEP 608.01(a).

### SUMMARY OF THE INVENTION

Sterilization by heat treatment is a well-established method to make food safe for human consumption. Casu marzu has never been treated this way because the Sardinians who consume this cheese do not consider it dangerous, so there was never a motivation to heat treat casu marzu. Furthermore, there is the perceived risk that such treatment will alter the taste of the cheese making it undesirable for consumers.

A previous attempt to legalize casu marzu involved ripening the cheese in controlled conditions where the flies and cheese were kept in a sealed storeroom to insure that the flies were grown in a controlled environment and did not introduce potentially harmful microbes, such as E coli or Salmonella, into the cheese (ref Mazzette). However, no attempt was made to kill the fly larvae, and the request to legalize the cheese made in this way was rejected by the European Food Safety Authority. In this effort to legalize casu marzu, it was assumed that live larvae in casu marzu did not pose a health risk, while randomly introduced microbes did, therefore there was no motivation to kill the larvae by temperature treatment once the microbial floral was defined and considered safe. It should be noted that many ripened cheeses contain large amounts of microbes and are considered safe.

During the infestation process of casu marzu, the cheese is altered by the metabolic activity of the larvae and microbes present in the cheese. This metabolic activity produces high levels of the biogenic amines tyramine, putrescine and cadaverine not found in non-infested sheep cheese (ref Manca). These compounds are also present in many other food products, such as Roquefort and Gouda cheeses, wines, sausages, and soy sauce (ref Stratton). A key realization in the present invention is that over a wide range of temperatures (≤0° C., ≥44° C.) these biogenic amines are temperature stable while live Piophila casei larvae exposed to the same temperatures are killed. Therefore, the larvae in casu marzu can be killed by temperature treatment without substantially altering the taste of the cheese.

### DETAILED DESCRIPTION OF THE INVENTION

The Azienda Sa Mandra Farm in Alghero, Italy on the island of Sardinia is a family run business sells the sheep cheese it produces to customers worldwide. All hygiene practices required by the Italian food safety authorities are followed and they are licensed to produce and sell sheep cheese.

On Sep. 28, 2022 ten 150 gram portions of casu marzu produced for personal consumption at the Azienda Sa Mandra Farm in Alghero, Sardinia, that had been ripened for 90 days by exposing sheep cheese to Piophila flies were placed in 200 ml Le Parfait glass jars. The jars were sealed and placed in a Rational steam cooker (Rational, AG Germany) for 60 minutes at 100° C. The casu marzu reached temperatures in excess of 90° ° C.in order to kill all organisms in the sample, essentially rendering the sample biologically inert.

On Sep. 29, 2022, fresh untreated casu marzu ripened 90 days was taste compared with the heat-treated cheese. The inventor and six Sardinian individuals who have experience making and eating casu marzu tasted these samples. The tasters were instructed to note the taste of the two samples and to compare. The heat-treated casu marzu was deemed to have essentially the same taste at the untreated casu marzu by all seven tasters. This is to be expected since the biogenic amines in casu marzu that give this cheese its unique taste are stable at 100° C.

Casu marzu treated at 100° C. for one hour has no living microbes, see the attached data from an independent food testing laboratory with ISO 17025 accreditation in Switzerland. Since the microbes found in casu marzu can resist temperatures up to 60° C. while fly larvae show 0% survival at 44° C., the fact that all microbes are killed by heating casu marzu at 100° C. for one hour strongly suggests that all of the fly larvae in the same sample have also been killed. The death of all larvae is confirmed by observing the cooked larvae after treatment. All larvae are stationary as expected of dead larvae.

Other methods to kill Piophila larvae in casu marzu such as irradiation, pressure treatment, and grinding the cheese to physically disrupt the larvae at ambient temperatures all suffer from disadvantages. Irradiation is expensive and not accepted by many consumers as a method to process foods. While both physical disruption to kill the larvae and pressure treatment are expensive and often do not result in killing essentially 100% of the larvae. Futhermore, all three of these approaches will not kill 100% of the microbes in casu marzu the way that treatment at 100° C. for one hour has proven to do. Killing 100% of microbes in a casu marzu sample has two advantages. First of all it insures that no pathological microbes are present and it also acts as a surrogate marker for Piophila casei killing, since these larvae are much more sensitive to heat compared to the microbes in the sample.

### Microbiology Data:

Total aerobic microbial count: not detectable (<10) [cfu/g] acc. to ISO 4833.
Anaerobic mesophilic bacteria: not detectable (<100) [cfu/g] acc. to ISO 4833.
Yeasts: not detectable (<100) [cfu/g] acc. to SLMB Chap. 56.
Molds: not detectable (<100) [cfu/g] acc. to SLMB Chap. 56.

### Nutritional Data:

Energy value, kcal 424 [kcal/100 g]
Moisture 30.63 [g/100 g]
Protein 26.63 [g/100 g]
Carbohydrates 1.4 [g/100 g]
Sugar, total <0.25 [g/100 g]
Fat 33.41 [g/100 g]
Fatty acid, monounsaturated 7.3 [g/100 g]
Fatty acid, saturated 24.8 [g/100 g]
Fatty acid, multiple saturated 1.31 [g/100 g]
NaCl (calculated from sodium) 3.43 [g/100 g]

### Biogenic Amine Levels:

Histamine 550 mg/kg
Tyramine 943 mg/kg
Cadaverine 158 mg/kg
Putrescine 607 mg/kg
Phenylethylamine 115 mg/kg
Spermidine <10 mg/kg
Tryptamine <10 mg/kg

a.

### REFERENCES

Monzon M A, Weidner L M, Rusch T W, Nehrozoglu S, Hamilton G. High Temperature Limits of Survival and Oviposition of Phormia regina (Meigen) and Lucilia sericata (Meigen). Insects. 2022 Oct. 28; 13(11):991. doi: 10.3390/insects13110991. PMID: 36354815.

Manca, G., Porcu, A., Ru, A., Salaris, M., Franco, M. A., & de Santis, E. P. L. (2015). Comparison of γ-aminobutyric acid and biogenic amine content of different types of ewe's milk cheese produced in Sardinia, Italy. Italian Journal of Food Safety, 4(2). doi.org/10.4081/ijfs.2015.4700

Peckenschneider, L. E., Pokorny, C., & Hellwig, C. A. (1952). Intestinal infestation with maggots of the “cheese fly” (Piophila casei). Journal of the American Medical Association, 149(3). doi.org/10.1001/jama.1952.72930200005011b

Mazzette, R., Colleo, M. M., Riu, G., Piras, G., Piras, F., Addis, M., Pes, M., Pirisi, A., Meloni, D., Mureddu, A., Spada, S., Fiori, M., Coinu, M., & Lentini, A. (2010). Production under controlled conditions of “casu marzu” cheese: effect of the Piophila casei colonization on microbial and chemical composition of the cheeses. Italian Journal of Food Safety, 1(7). doi.org/10.4081/ijfs.2010.7.45

Gehring W J, Wehner R. Heat shock protein synthesis and thermotolerance in Cataglyphis, an ant from the Sahara desert. Proc Natl Acad Sci USA. 1995 Mar. 28; 92(7):2994-8. doi: 10.1073/pnas.92.7.2994. PMID: 7708762; PMCID: PMC42345.

Turck, D., Bohn, T., Castenmiller, J., de Henauw, S., Hirsch-Ernst, K. I., Maciuk, A., Mangelsdorf, I., McArdle, H. J., Naska, A., Pelaez, C., Pentieva, K., Siani, A., Thies, F., Tsabouri, S., Vinceti, M., Cubadda, F., Frenzel, T., Heinonen, M., Marchelli, R., Knutsen, H. K. (2021). Safety of frozen and dried formulations from whole yellow mealworm (Tenebrio molitor larva) as a novel food pursuant to Regulation (E U) 2015/2283. In EFSA Journal (Vol. 19, Issue 8). https://doi.org/10.2903/j.efsa.2021.6778

1. A method to render cheese containing live fly larvae safe for human consumption by killing said larvae through exposure to temperatures below 0° C. or above 44° C. while at the same time leaving biogenic amines in said cheese intact.

2. The method of claim 1 wherein said temperature is greater than 90° C.

3. The method of claim 1 wherein said fly larvae are of the species Piophila casei.

4. The cheese in claim 1 wherein said cheese is casu marzu.

5. The biogenic amine in claim 1 wherein said biogenic amine is tyramine.

6. The biogenic amine in claim 1 wherein said biogenic amine is putrescine.

7. The biogenic amine in claim 1 wherein said biogenic amine is cadaverine.
